(19) United States
(12) Patent Application Publication
(10) Pub. No.: US 2021/0206080 A1
(43) Pub. Date: Jul. 8, 2021

(54) BUILD MATERIAL FUSING

(71) Applicant: HEWLETT-PACKARD DEVELOPMENT COMPANY, L.P., Houston, TX (US)

(72) Inventors: Arthur H. BARNES, Vancouver, WA (US); William F. WINTERS, Vancouver, WA (US)

(73) Assignee: HEWLETT-PACKARD DEVELOPMENT COMPANY, L.P., Houston, TX (US)

(21) Appl. No.: 16/074,458

(22) PCT Filed: Feb. 10, 2017
(86) PCT No.: PCT/US2017/017386

§ 371 Date: Aug. 1, 2018

(51) Int. Cl. B29C 64/295; B29C 64/153; B29C 64/165; B29C 64/291; B29C 64/25; B29C 64/364; B29C 64/393

(52) U.S. Cl. CPC B29C 64/295; B29C 64/153; B29C 64/165; B33Y 10/00; B29C 64/25; B29C 64/364; B29C 64/393; B29C 64/291

(57) ABSTRACT

An additive manufacturing build material fusing apparatus may include a housing, a window, a thermal reflector between the housing and the window, a first interior behind the reflector between the housing and the reflector, a second interior in front of the reflector between the reflector and the window, a heating device in the second interior, an airflow passage and a fan. The heating device may include at least one heating unit. The airflow passage may have an inlet connected to the first interior, a connector passage connecting the first interior to the second interior and an outlet connected to the second interior. The fan moves air along the airflow passage.

### BACKGROUND

Additive manufacturing systems, such as three-dimensional (3-D) printers, employ an additive manufacturing process to create objects from plastic or other materials. Such additive manufacturing systems include a build bed or build area in which one or more objects are generated during a build cycle. In some systems, an operator may load digital files containing digital representations of each of the objects to be generated during a build cycle. The digital representations of the objects contained in a digital file are digitally sliced into layers. During the build cycle, the additive manufacturing system forms such layers upon one another to generate the three-dimensional objects.

### BRIEF DESCRIPTION OF THE DRAWINGS

FIG. 1 is a schematic diagram of an example fusing apparatus.

FIG. 2 is a top sectional view of another example fusing apparatus.

FIG. 3 is a bottom sectional view of the example fusing apparatus of FIG. 2.

FIG. 4 is a flow diagram of an example method for operating an example fusing apparatus.

FIG. 5 is a schematic diagram of another example fusing apparatus.

FIG. 6 is a schematic diagram of an example additive manufacturing system.

FIG. 7 is a perspective view of portions of an example additive manufacturing system.

FIG. 8 is a perspective view of an example fusing apparatus of the example additive manufacturing system of FIG. 7.

FIG. 9 is a sectional view of the example fusing apparatus of FIG. 8.

FIG. 10 is a cross sectional view of the example fusing apparatus of FIG. 8.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Additive manufacturing systems may use heating devices to fuse build material to form the different layers or slices of a three-dimensional object. Such heating devices direct radiation at the build material, such as powder, to fuse the build material. During operation of such heating devices, the heating devices themselves as well as components associated with the heating devices may also be heated to temperatures that, if not addressed, may damage the heating devices and the associated components. For example, at temperatures above 350 degrees Celsius, seals or other components may be damaged.

Disclosed herein are examples of an additive manufacturing build material fusing apparatus that provides for cooling of the heating device. Disclosed herein are examples of a build material fusing apparatus that facilitates control over the temperature of the heating device and surrounding components to maintain performance of the additive manufacturing system, prolong the life of the fusing apparatus and reduce undesirable unwanted re-radiation in the far infrared portion of the electromagnetic spectrum. The build material fusing apparatus controls the temperature by directing air through regions behind a reflector associated with the heating device, cooling the housing and the components associated with the heating device. The build material fusing apparatus further control the temperature by circulating the air from behind the reflector through regions in front of the reflector, along the heating devices, to cool the heating devices themselves.

Disclosed herein is an additive manufacturing build material fusing apparatus that may include a housing, a window, a thermal reflector between the housing and the window, a first interior behind the reflector between the housing and the reflector, a second interior in front of the reflector between the reflector and the window, a heating device in the second interior, an airflow passage and a fan. The heating device may include at least one heating unit. The airflow passage may have an inlet connected to the first interior, a connector passage connecting the first interior to the second interior and an outlet connected to the second interior. The fan moves air along the airflow passage.

Disclosed herein is an example method for cooling an additive manufacturing build material fusing apparatus. The method may comprise activating a heating device within a first interior bounded by a reflector and a window, directing air through a second interior bounded by a housing and the reflector to preheat the air, and directing the preheated air from the second interior through the first interior to cool the heating device.

Disclosed herein is an example additive manufacturing system. The system may include a build area, a build material distributor, a coalescing agent distributor and a fusing apparatus. The fusing apparatus may include a housing, a window, a thermal reflector between the housing and the window, a first interior behind the reflector between the housing and the reflector, a second interior in front of the reflector between the reflector and the window, a heating device in the second interior, an airflow passage and a fan. The heating device may include at least one heating unit. The airflow passage may have an inlet connected to the first interior, a connector passage connecting the first interior to the second interior and an outlet connected to the second interior. The fan moves air along the airflow passage.

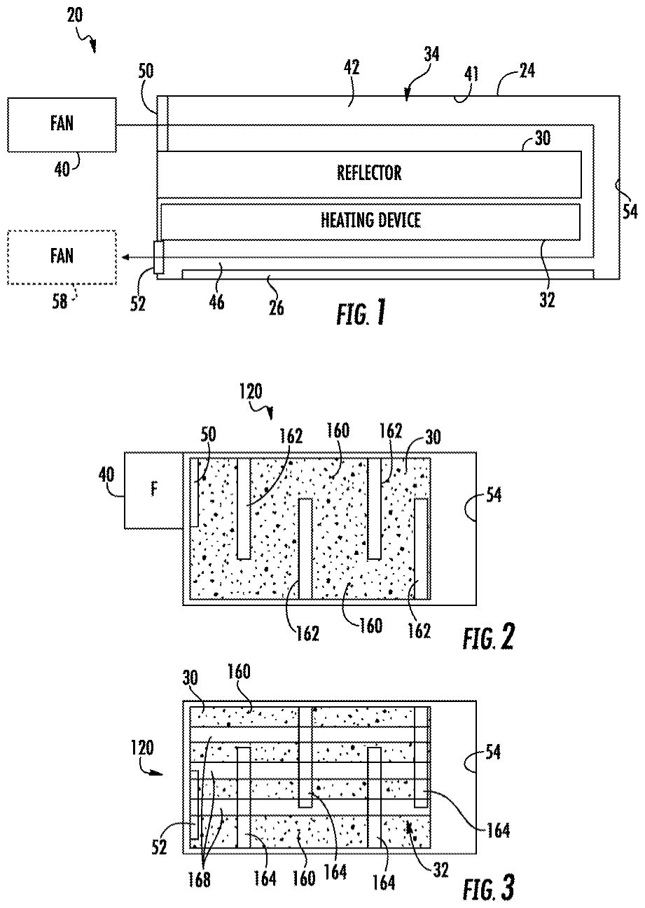

FIG. 1 is a diagram schematically illustrating an example additive manufacturing build material fusing apparatus 20 for use as part of an additive manufacturing system. Fusing apparatus 20 facilitates the fusing of building material in an additive manufacturing system while cooling the heating devices and associated components of the fusing apparatus. Fusing apparatus 20 comprises housing 24, window 26, thermal reflector 30, heating device 32, airflow passage 34 and fan 40.

Housing 24 comprises an enclosure having an interior 41 containing reflector 30 and heating device 32. In one implementation, the enclosure provided by housing 24 is substantially sealed (but for an inlet and outlet associated with an airflow passage as described below) to inhibit the entry of contaminants which might otherwise impair the performance of reflector 30 or heating device 32. Although illustrated as elongated and rectangular, housing 24 may have a variety of sizes and shapes.

Window 26 comprises an optical opening through which radiation from heating device 32 may pass, impinging the building material to heat and fuse the building material. In one implementation, window 26 comprises a translucent or transparent panel that transmits the radiation from the interior 41 of housing 24 towards the building material. In such an implementation, window 26 further inhibit or impedes contaminants from entering enclosure 26 where they might otherwise become deposited upon reflector 30 and/or heating device 32. In one implementation, window 26 comprises an optical filter, facilitating the transmission of selected wavelengths of radiation or light there through.

Thermal reflector 30 comprises at least one structure to reflect heat or radiation emitted by heating device 32 towards window 26. In one implementation, thermal reflector 30 comprises at least one panel of a highly reflective material to near, mid and far infrared radiation such as, but not limited to aluminum or gold. In one implementation, thermal reflector 30 partially wraps about heating device 32 to further direct reflected heat downward through window 26. In one implementation, thermal reflector 30 comprises a plurality of elliptical reflectors that partially wrap about or receive associated heating units of heating device 32.

Thermal reflector 30 is supported within the interior 41 of housing 24 and partitions the interior 41 into back interior 42 and front interior 46. Back interior 42 extends behind reflector 30 between reflector 30 and housing 24. Front interior 46 extends in front of reflector 30 between reflector 30 and window 26.

Heating device 32 comprise a device to heat and fuse the building material and applied coalescing agents of the additive manufacturing system in which fusing apparatus 20 is employed. Heating device 32 is supported by apparatus within front interior 46 opposite to window 26. Heating device 32 directs radiation through window 26 towards the building material. Radiation emitted by heating device 32 rearwardly is reflected by reflector 30 back through window 26. The radiation emitted by heating device 32 is sufficient to raise the temperature of the impinged building material and coalescing agent to a temperature so as to fuse the building material. For example, in one implementation in which the building material comprises a powder, the radiation emitted by heating by 32 and impinging the powder and coalescing agent is sufficient to raise the temperature of the powder and coalescing agent to above a glass transition temperature of the powder and coalescing agent so as to fuse or melt the powder and coalescing agent.

Heating device 32 may comprise a single or a plurality of heating units. For example, one implementation, heating device 32 may comprise multiple heating units such as multiple fusing units arranged parallel to one another within housing 24. In another implementation, heating device 32 may comprise multiple fusing units arranged end-to-end within housing 24. In another implementation, heating device 32 may comprise multiple fusing units arranged end-to-end in rows that are parallel. In still other implementations, heating device 32 may comprise a single elongated fusing unit.

At least one fusing unit of heating device 32 comprises an energy source that is able to uniformly apply energy to the build material. The fusing unit(s) is/are to deliver an amount of energy to the build material so as to raise the temperature of the build material on which a coalescing agent has been applied above the glass transition temperature of the build material, as modified by any coalescent agents. In one implementation, the fusing unit(s) of heating device 32 comprises an infrared or near infrared light source.

In other implementations, the fusing units of heating device 32 may comprise other energy sources, thermic sources or other light sources. For example, in other implementations, other types of energy may be applied by heating device 32 such as microwave energy, halogen light, ultraviolet light and ultrasonic energy or the like. The type of energy as well as the duration of application of energy may vary depending upon factors such as the characteristics of heating device 32, the characteristics of the build material and the characteristics of any coalescence or fusing agents applied to the build material during the additive manufacturing process.

In one implementation, the fusing unit(s) of heating device 32 comprises a plurality of quartz infrared halogen lamps to provide a uniform, high intensity irradiation to the powder of the build material. In one implementation, each of the lamps comprises a 1400 W lamp having a color temperature of 2750 K. In such an implementation, the lamps serving as the fusing units are operable to heat the building material (with any coalescing agents) to a temperature of at least 210° C., a temperature which is above the melting temperature of the building material and coalescing agents. In other implementations, heating device 32 may comprise other sources for delivering sufficient amounts of energy to the build material with coalescing agent so as to fuse the build material to which the coalescing agent has been applied.

In one implementation, heating device 32 may comprise heating units that include both at least one fusing unit (described above) and at least one warming unit. The warming units comprise sources of energy, such as lamps, that are to pre-warm the build material prior to fusing of the build material. Such warming units deliver energy to the build material so as to warm the build material to a temperature below its melt temperature. For example, in one implementation, such warming units may warm the building material to temperatures of between 135° C. and 175° C. and nominally between 155° C. and 165° C. In one implementation, such warming unit may comprise a quartz infrared halogen lamp having a color temperature less than that of the individual fusing units. In one implementation, each warming unit may comprise such a lamp having a color temperature of 1800° Kelvin. In yet other implementations, heating device 32 comprise other types of warming units or may omit such warming units.

Airflow passage 34 comprises an air conduit extending through housing 24 through which air flows to cool interior components of fusing apparatus 20. Airflow passage 34 comprises inlet 50, outlet 52 and connector passage 54. Inlet 50 comprises an opening through which air, at a temperature of between 20° C. and 30° C., is supplied to back interior 42. In one implementation, inlet 50 connected to ambient air, the air surrounding housing 24. In another implementation, inlet 50 is connected to a hose or other conduit by which air exterior to the additive manufacturing system may be drawn into Interior 42.

Outlet 52 comprises an opening connected to front interior 46 through which air, which is absorb heat from reflector 30 and from heating device 32, may be discharged from housing 26. Connector passage 54 comprises a conduit connecting back interior 42 to front interior 46. In one implementation, connector passage 54 has a cross-sectional area sufficient to allow air flow at a rate of at least 75 cubic feet per minute (CFM) and nominally at least 100 CFM from back interior 42 to front interior 46.

In the example illustrated, inlet 50 and outlet 52 are on the same and of housing 24. Airflow passage 34 is U-shaped such that air moves across an entire length of housing 26 and reflector 30, from inlet 50 to connector passage 54, before turning around and connector passage 54 and flowing across the entire length of housing 24 and heating device 32, prior to exiting through outlet 52. As a result, heat is absorbed by the air flowing behind reflector 30 along an entire length prior to entering interior 46. The air entering interior 46 flows across and cools substantially the entire length of heating device 32 prior to being discharged.

Fan 40 comprises a blower or other device to move air through airflow passage 34. In one implementation, fan moves air through airflow passage 34 at a rate of at least 75 CFM and nominally at least 100 CFM. In the example illustrated, fan 40 blows ambient air through inlet 50. In one implementation, fan 40 is connected to and supported by housing 24. In another implementation, fan 40 is supported by a housing of the overall additive manufacturing system, wherein a conduit extending from fan 40 is connected to inlet 50. As illustrated by broken lines, in other implementations, apparatus 20 may additionally or alternatively include a fan 58 which draws air from interior 41 through outlet 52.

Although fan 42, 58 is illustrated as moving air through an airflow passage 34 having a U-shape, in other implementations, airflow passage 34 may have other circulation routes. For example, FIGS. 2 and 3 illustrate fusing apparatus 120, an alternative implementation of fusing apparatus 20. Fusing apparatus 120 is similar to fusing apparatus 20 except that the fusing apparatus 120 additionally comprises airflow directing perforations 160 and airflow directing baffles 162, 164. Although not illustrated, FIG. 2 is a sectional view of apparatus 120 taken through back interior 42 in a direction towards window 26. FIG. 3 is a sectional view of apparatus 120 taken through front interior 46 in a direction towards reflector 30. Those components of fusing apparatus 120 which correspond to components of fusing apparatus 20 are numbered similarly.

As shown by FIGS. 2 and 3, reflector 30 may include a plurality of perforations along its length (left to right in FIG. 1) or at selected portions of reflector 30, wherein the perforations allow air to flow from interior 42 to front interior 46 and wherein the perforations 160 are sufficiently small such that air entering interior 42 through inlet 50 passes through all of such perforations to provide cooling along the entire length of reflector 30 and heating device 32. As shown by FIG. 2, baffles 162 extend between reflector 30 and housing 26 within back interior 42. Baffles 162 create a serpentine flow of air back and forth along the back side of reflector 30. By increasing the dwell time of the airflow in interior 42, there is able to absorb a greater amount of heat prior to exiting interior 42 through connector passage 54.

As shown by FIG. 3, baffles 164 extend between reflector 30 and window 26 within front interior 46. Baffles 164 create a serpentine flow of air back and forth along the front side of reflector 30 across heating units 168 of heating device 32. By increasing the dwell time of the airflow in interior 46, the air is able to absorb a greater amount of heat prior to exiting interior 46 through connector passage outlet 52.

Although each of perforations 160, baffles 162 and baffles 164 are illustrated as being utilized in combination with one another in fusing apparatus 120, in other implementations, the fusing apparatus 120 may comprise any combination of perforations 160, baffles 162 and baffles 164. For example, fusing apparatus 120 may just include the perforations 160 while omitting baffles 162, 164. Fusing apparatus 120 may omit perforations 160 while including baffles 152, 164. Fusing apparatus 120 may include baffles 162 without baffles 164 (or vice versa) and without perforations 160. Fusing apparatus 120 may include baffles 162 without baffles 164 (or vice versa) and with perforations.

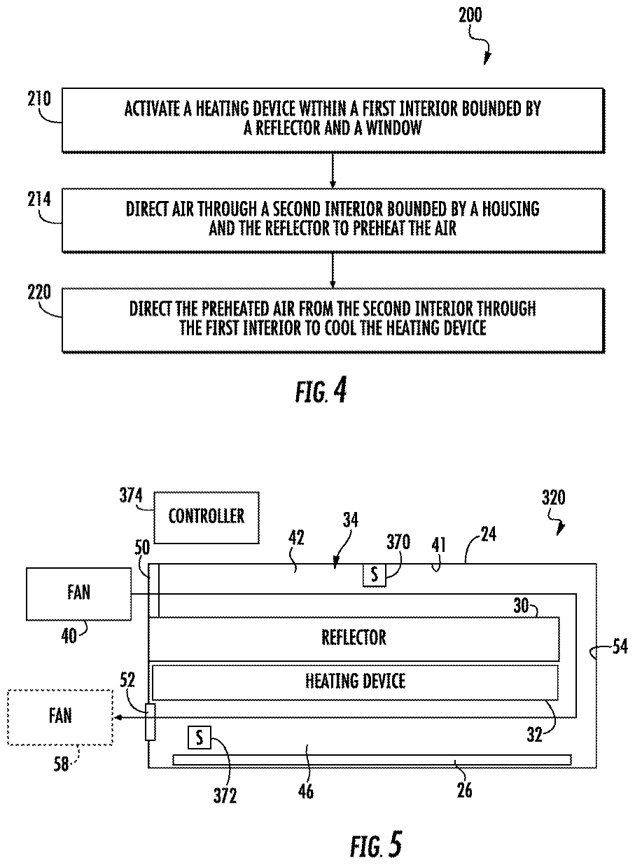

FIG. 4 is a flow diagram of an example method 200 for cooling a fusing apparatus, such as apparatus 20 or apparatus 120. Method 200 facilitates the fusing of building material in an additive manufacturing system while cooling the heating devices and associated components of the fusing apparatus. Although method 200 is described as being carried out by apparatus 20, it should be appreciated that method 100 may be carried out with any of the fusing apparatus or additive manufacturing system described hereafter, or other similar fusing apparatus or additive manufacturing systems.

As indicated by block 210, a heating device, such as heating device 32, is activated within a first interior 46 which is bounded by reflector 30 and window 26. The heating device directs radiation through the window 26 onto the build material to fuse or melt selected portions of the build material (those portions to which a coalescing agent has been applied) so as to form a layer of a three-dimensional article or product.

As indicated by block 214, fan 40 (and/or fan 58) directs air through the back interior 42 which is bounded by housing 24 and reflector 30. The air passing through interior 42 along the back side of reflector 30 absorbs heat from reflector 30 and the various structures of housing 34 to cool reflector 30 and such various structures. This results in the air being warmed or preheated to a temperature greater than the ambient air outside of housing 24 but less than the temperature of the air within interior 46 adjacent to heating device 32.

As indicated by block 220, fan 40 (and/or fan 58) continues to direct the preheated air within interior 42 from interior 42 through interior 46 so as to cool heating device 32. In apparatus 20, the air is directed through connector passage 54 from interior 42 to interior 46. In the example illustrated, the areas directed along a U-shaped path confluence veggie across the entire length of reflector 30 and said veggie across the entire length of heating device 32 prior to being discharged through outlet 52. As described above with respect to FIGS. 2 and 3, air may be directed along an airflow passage having other shapes.

In one implementation, the heating device comprise at least one energy source having a color temperature of typically 2750 degrees Kelvin so as to facilitate fusing or melting of the build material with a coalescent agent, such as a printing liquid. In one implementation, the heating device comprises at least one energy source having a color temperature of 2750° Kelvin. In some implementations, the heating device may additionally include at least one energy source having a color temperature of at least 1200 degrees Kelvin and no greater than 2500 degrees Kelvin to warm the build material without fusing the build material. In one implementation, the additional warming unit or units of the heating device have a color temperature of 1800° Kelvin.

In one implementation, the air that is directed through the second interior, interior 42, comprise air drawn from the ambient environment surrounding the fusing apparatus or surrounding exterior of additive manufacturing system. In one implementation, the temperature of the ambient air ranges from 20° C. to 30° C. In one implementation, air is directed through the first and second interiors at a rate of at least 75 ft.³ per minute, and nominally at least 100 ft.³ per minute. In one implementation, air exiting interior 42 has a temperature of between 30° C. and 70° C. while the air exiting outlet 52 has a temperature of between 50° C. and 120° C.

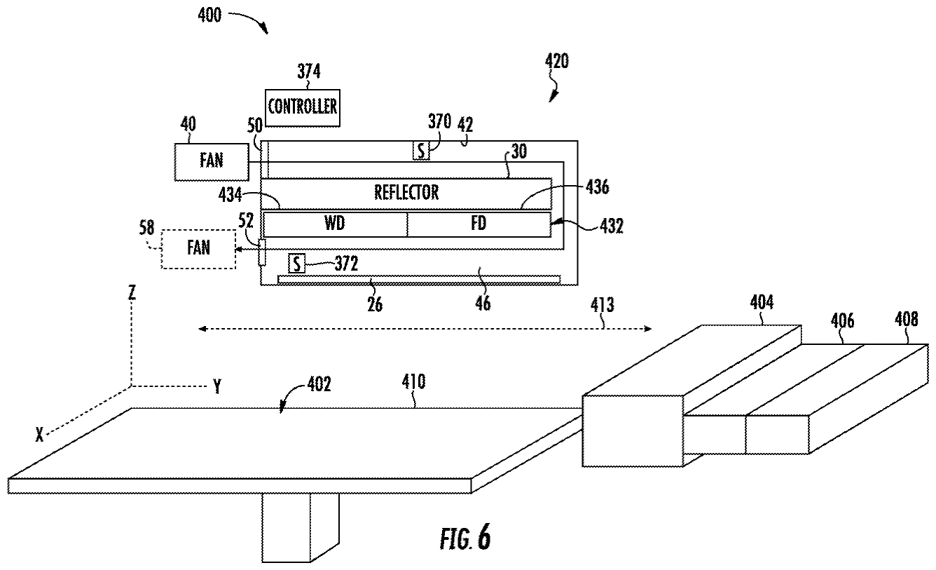

FIG. 5 is a schematic diagram of another example fusing apparatus 320. Fusing apparatus 320 is similar to fusing apparatus 20 except that fusing apparatus 320 additionally comprises closed-loop feedback control to assist in controlling the rate at which air is directed through interiors 42 and 46. Those components of apparatus 320 which correspond to components of apparatus 20 are numbered similarly. As shown by FIG. 5, apparatus 320 additionally comprises sensors 370, 372 and controller 374.

Sensors 370, 372 comprise temperature sensors that output signals indicating the temperature of the air within interiors 42 and 46, respectively. In other implementations, sensor 370, 372 may sense other temperatures, such as the temperature of reflector 30 and portions of heating device 32, respectively. Signals from sensors 370, 372 are communicated to controller 374 in a wired or wireless fashion.

Controller 374 comprise electronics that controls the operation of fan 40 (and/or fan 58) based upon signals from sensors 370 and 372. In one implementation, controller 374 comprises an integrated circuit or an application-specific integrated circuit. In another implementation, controller 374 comprises a processing unit and instructions for the processing unit that are stored in a non-transitory computerize readable medium.

In one implementation, controller 374 adjusts the rate at which air is moved through interiors 42 and 46 based upon signals from sensors 370, 372. In one implementation controller 374 control such airflow such that the temperature of reflector 30 and those exterior portion of housing 24 do not exceed a predetermined maximum threshold that might otherwise damage or harm fusing apparatus 320 or components of the additive manufacturing system. In one implementation, controller 374 further controls such airflow such that heating device 32 is maintained at a temperature within a desirable operating range.

For example, in one implementation, the air flow cooling heating device 32 is controlled such that the surface of the heating device 32 is maintained at a temperature less than or equal to 350 degrees Celsius to minimize or avoid damage to the heating unit of the heating device 32, such as damage to molybdenum foil seals of the individual heating units or lamps. In one implementation, the air flow cooling device 32 is controlled such that the surface of the heating device is maintained at a temperature of at least 250° C. to also avoid damage to the heating unit of the heating device 32, such as to avoid condensation of tungsten on the inside of the quartz tube. In some implementations, one of sensor 370, 372 may be omitted. In yet other implementations, fusing apparatus 320 may include sensors at different locations in those illustrated or additional sensors at other locations.

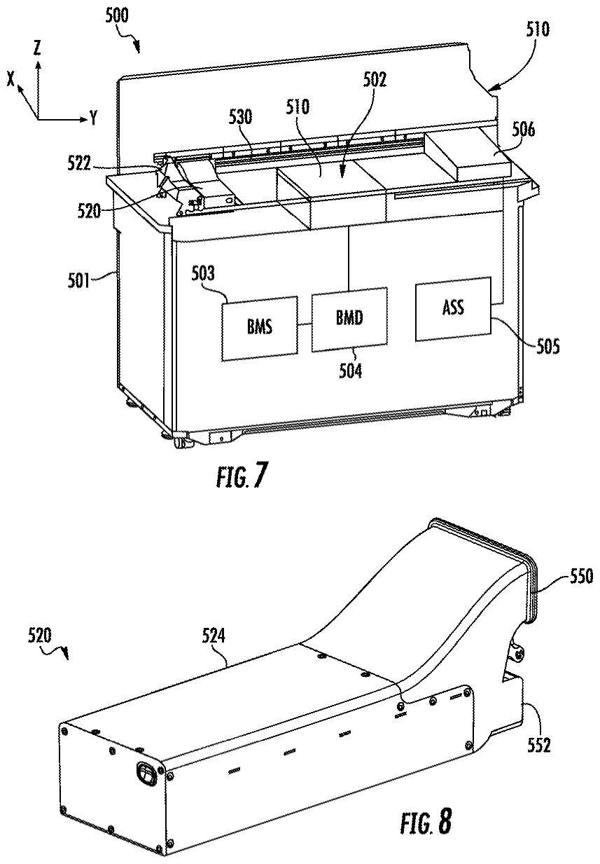

FIG. 6 is a schematic diagram of an example additive manufacturing system 400. System 420 comprises build area 402, build material distributor 404, fusing control agent distributors 406, 408 and fusing apparatus 420. Build area 402 comprises comprise a region or volume in which build material is distributed by build material distributor 404. In one implementation, build area 402 comprises a support 410 that underlies build material. Support 410 may be vertically raised and lowered (in the z-axis) such that new layers of build material may be deposited in a predetermined gap is maintained between the surface of most recently deposited layer of build material and a lower surface of agent distributors 406, 408. In yet other implementations, support 410 may not be movable in the z-axis, wherein agent distributors 406, 408 are movable in the z-axis.

Build material distributor 404 comprise a device that distributes build material across support 410 of build area 402. Build material distributor provides a layer of build material on the support. Examples of build material distributors include, but not limited to, a wiper blade and a roller. Such build material may be supplied to distributor 404 from a build material store, such as a hopper. In the example illustrated, build material distributor 404 is movable across the length (y-axis) of support 410 deposited layer of build material as indicated by arrows 413.

In one implementation, the build material distributed by distributor 404 comprises a powder. In one implementation, the build material comprises a powdered semi-crystalline thermoplastic material. One example of a build material comprises Nylon 12, commercially available from Sigma-Aldrich Co. LLC. Another example build material may comprise PA2200 commercially available from Electro Optical System EOS Gmbh. Other examples of build material include, but are not limited to, powdered metal materials, powdered composited materials, powder ceramic materials, powdered glass materials, powdered resin material, powdered polymer materials and the like.

Agent distributors 406, 408 comprise devices that selectively deliver a coalescing agent and a detailing agent, respectively, to selected portions of the current layer of build material residing on support 410 in build area 402. In one implementation, such selected delivery of the coalescence agent and the detailing agent is pursuant to a pattern defined by data derived by a model of a three-dimensional article or object to be created. Such coalescent agents control what portions of the present layer of build material are fused in response to energy applied by heating device 32 of fusing apparatus 320. In one implementation, agent distributors 406,408 comprise liquid ejectors that selectively eject coalescent agents in the form of liquids onto the build material which, in some implementations, may comprise a powder.

In one implementation, agent distributors 406, 408 may comprise print heads, such as thermal resistive or thermal ejectors or piezo ejectors. Thermal ejectors apply electrical current to an electrical resistor to generate sufficient heat so as to vaporize the adjacent liquid, creating a bubble that expels liquid through an adjacent nozzle. Piezo ejectors use piezo-resistive elements that change shape in response to an applied electrical current to move a flexible membrane so as to expel liquid through a nozzle.

In one implementation, agent distributors 406, 408 deliver drops of an agent at a resolution of between 300 to 1200 dots per inch. In other implementations, the agent distributors may deliver drops of agent at a higher or lower resolution. In one implementation, each drop may be in the order of 10 pico liters per drop. In other implementations, agent distributors 406, 408 may deliver higher or lower drop sizes. In one implementation, agent distributor 406 may deliver differently sized drops as compared to agent distributor 408. In one implementation, distributors 406, 408 may be part of a single head. In some implementations, distributor 408 may be omitted.

In one implementation, distributor 406 distributes a coalescing agent. The coalescing agent causes the building material to which the coalescing agent is applied to heat up to a temperature above a melting temperature glass transition temperature of the build material in response to the applied energy from heating device 32. Those portions of the layer of build material which have not received the coalescing agent do not reach the glass transition temperature and do not melt in response to the energy applied from heating device 32. I

In one implementation, the coalescent agent is an ink-type formulation comprising carbon black. For example, in one implementation, the ink formulation comprising ink known as CM997A commercially available from Hewlett-Packard Company. In some implementations, such an ink may additionally comprise an infrared light absorber. For example, in one implementation, such an ink may additionally comprise a near infrared light absorber. In some implementations, such an ink may additionally comprise a visible light absorber. Examples of inks comprising visible light enhancers include dye-based color inks and pigment based colored inks. Examples of such inks include, but are not limited to, CE039A and CE042A commercially available from Hewlett-Packard Company.

In one implementation, distributor 408 distributes a detailing agent, sometimes referred to as the coalescence modifier agent. The detailing agent has a composition to modify the effects of a coalescing agent. In one implementation, the detailing agent may reduce or manage the effects of coalescence bleed. For example, in one implementation, the detailing agent may improve the definition or accuracy of an object edges are surfaces or reduce surface roughness. In one implementation, the detailing agent may be delivered interspersed with coalescing agent, facilitating the modification of object properties.

In one implementation, the detailing agent may act to produce a mechanical separation between individual particles of the build material, such as preventing such products from joining together and hence preventing them from solidifying to form a portion of a generated three-dimensional object. One example such a detailing agent may comprise a liquid that comprises solids. Such an agent may be, for example, a colloidal ink, a die based ink, or a polymer-based ink.

Such an agent may, after being delivered to a layer of build material, cause a thin layer of solids to cover or at least partially cover a portion of the build material. In one implementation, the thin layer solids is formed after evaporation of any carrier liquid of the detailing agent.

In another implementation, the detailing agent may comprise solid particles that have an average size less than the average size of particles of the build material. In some implementations, the molecular mass of the detailing agent and its surface tension may enable the detailing agent to penetrate sufficiently into the build material. In one implementation, such an agent may also have a high solubility such that each drop of the detailing agent comprises a high percentage of solids. One example of such a detailing to comprise a salt solution.

In another implementation, the detailing agent may comprise a commercially available ink known as CM996A from Hewlett-Packard Company. In another implementation, the coalescence modifying agent may comprise an ink commercially known as CN673A available from Hewlett-Packard Company.

In still other implementations, the detailing agent may modify the effects of the coalescing agent by preventing the build material from reaching temperatures above its melting point. For example, a liquid may exhibit a suitable cooling effect that may be used as a detailing agent. When such an agent is delivered to the build material, energy applied to the build material may be absorbed by the detailing agent causing the evaporation thereof, which may inhibit the build material on which the colas modifier agent has been delivered or is penetrated from reaching the melting point of the build material. In one implementation, the coalescence modifying agent may comprise a high percentage of water. In yet other implementations, other types of detailing agents may be utilized.

In yet other implementations, the detailing agent may increase the degree of coalescence. For example, a detailing agent may have a surface tension modifier to increase the wettability of particles of build material. In one implementation, such a detailing agent may comprise a suitable plasticizer. In some implementations, detailing agent distributor 408 may be omitted.

Fusing apparatus 420 is similar to fusing apparatus 320 described above except that fusing apparatus 420 comprises heating device 432 in lieu of heating device 32. Heating device 432 comprises warming device 434 and fusing device 436. Warming device 434 comprises a lamp or multiple lamps that pre-warm the build material prior to fusing of the build material. Such warming units deliver energy to the build material so as to warm the build material to a temperature below its glass transition temperature. For example, in one implementation, such warming units may warm the building material to temperatures of between 145° C. and 175° C., and nominally between 155° C.'s and 165° C. In one implementation, the warming unit or units of warming device 434 may comprise a quartz infrared halogen lamp having a color temperature less than that of individual fusing units of fusing device 436. In one implementation, each warming unit may comprise such a lamp having a color temperature of 1800° Kelvin. In yet other implementations, heating device 32 comprise other types of warming units or may omit such warming units.

Fusing device 432 comprises at least one energy source having a color temperature of typically 2750 degrees Kelvin so as to facilitate fusing or melting of the build material on which a coalescing agent from distributor 408 has been applied. In one implementation, the heating device comprises at least one energy source having a color temperature of 2750° Kelvin. In other implementations, fusing device 432 may comprise other energy sources that deliver sufficient energy to the build material on which the coalescing agent has been applied to fuse the build material.

In operation, build material distributor 404 forms a layer of build material on support 410. The agent distributors 406 and 408 selectively apply a coalescing agent and a detailing agent to the layer of build material pursuant to data regarding the three-dimensional object to be created. Thereafter, fusing apparatus 320 applies heat to the build material and applied agents to fuse those portions of the build material to which the coalescing agent has been applied. In one implementation, distributors 406, 408 as well as fusing apparatus 320 are moved in the directions indicated by arrows 413 over and across support 410 of build area 402 by a carriage or other mechanism. Once such solidification occurs, the process is repeated to form the next slice or layer of the three-dimensional article or object being created. During use of fusing apparatus 320, controller 374 directs fan 40 (and/or 58) to direct air through interior 42 and through interior 46 to cool fusing apparatus 420 and maintain heating device 32 within an appropriate temperature range.

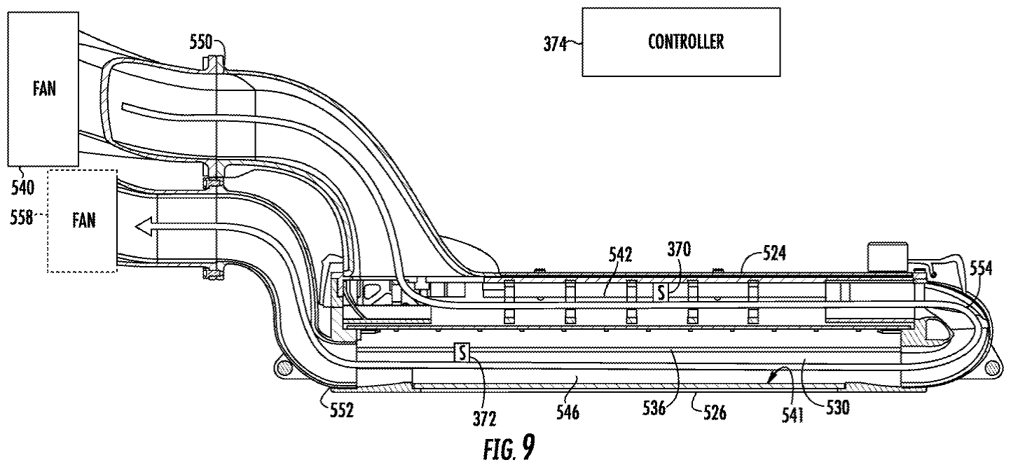

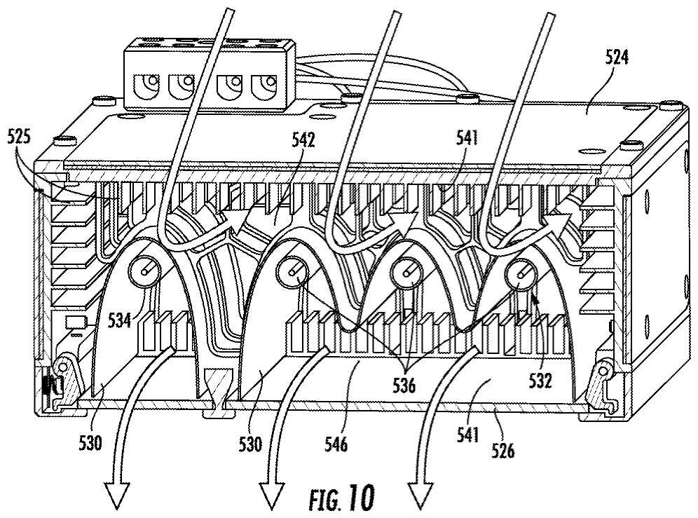

FIGS. 7-10 illustrate another example additive manufacturing system 500. Like system 400, system 500 utilizes a fusing apparatus that provides for cooling of the heating device and surrounding components to maintain performance of the additive manufacturing system and to prolong the life of the fusing apparatus. Like system 400, system 500 utilizes a material fusing apparatus that controls the temperature by directing air through regions behind a reflector associated with the heating device, cooling the housing and the components associated with the heating device. The fusing apparatus further controls the temperature by circulating the air from behind the reflector through regions in front of the reflector, along the heating devices, to cool the heating devices themselves. System 500 comprises housing 501, build area 502, build material supply system 503, build material distributor 504, agent supply system 505, agent distributor 506, ejector servicing station 508 and fusing apparatus 520. Housing 501 supports remaining components of system 500.

Build area 502 comprises a region or volume in which build material is distributed by build material distributor 504. In one implementation, build area 502 comprises a support 510 that underlies build material. Support 510 may be vertically raised and lowered (in the z-axis) such that new layers of build material may be deposited in a predetermined gap is maintained between the surface of most recently deposited layer of build material and a lower surface of agent distributor 506. In yet other implementations, support 510 may not be movable in the z-axis, wherein agent distributor 506 movable in the z-axis.

Build material supply 503 supply build material, such as powder, to build material 504. Examples of the build material that may be utilized in system 500 are described above with respect to system 400.

Build material distributor 504 comprise a device that distributes build material across support 510 of build area 502. Build material distributor provides a layer of build material on the support. Examples of build material distributors include, but not limited to, a wiper blade and a roller. In the example illustrated, build material distributor 504 is movably supported by a carriage and movable across the length (y-axis) of support 510.

Agent supply system 505 supplies at least one fusing control agent to distributor 506. In one implementation, agent supply system 505 supplies a coalescing agent to distributor 506. Examples of such a coalescing agent are described above with respect to system 400. In one implementation, agent supply system 505 may additionally supply a coalescent modifying agent for selective application to the build material in build area 502 by distributor 506. Examples of such coalescence modifying agents are described above with respect to system 400.

Agent distributor 506 comprise at least one device that selectively delivers the coalescing agent, and in some implementations, a coalescence modifying agent, to selected portions of the current layer of build material residing on support 510 in build area 502. In one implementation, the selected delivery of the coalescing agent or the detailing agent is pursuant to a pattern defined by data derived by a model of a three-dimensional article or object to be created. Such fusing control agents control what portions of the present layer of build material are fused in response to energy applied by fusing apparatus 520. In one implementation, agent distributor 506 comprises liquid ejectors that selectively eject agents in the form of liquids onto the build material.

In one implementation, agent distributor 506 may comprise print heads, such as thermal resistive or thermal ejectors or piezo ejectors. Thermal ejectors apply electrical current to an electrical resistor to generate sufficient heat so as to vaporize the adjacent liquid, creating a bubble that expels liquid through an adjacent nozzle. Piezo ejectors use piezo-resistive elements that change shape in response to an applied electrical current to move a flexible membrane so as to expel liquid through a nozzle.

In one implementation, agent distributor 506 delivers drops of a fusing control agent at a resolution of between 300 to 1200 dots per inch. In other implementations, the agent distributors may deliver drops of the fusing control agent at a higher or lower resolution. In one implementation, each drop may be in the order of 10 pico liters per drop. In other implementations, agent distributor 506 may deliver higher or lower drop sizes. In the example illustrated, agent distributor 506 is supported by a carriage movable in the Y-axis. In some implementations, agent distributor 506 may additionally selectively apply or deposit a coalescence agent modifier onto the build material.

Fusing apparatus 520 is similar to fusing apparatus 420 described above. Fusing apparatus 520 is movable in the Y-axis over and across build area 502 by an associated carriage. As fusing apparatus 520 traverses build area 502, fusing apparatus 520 pre-warms the build material and deposited fusing control agents. Fusing apparatus 520 further applies energy to the build material and deposited fusing control agents to fuse selected portions of the layer of build material to form a slice of the three-dimensional article being created.

FIGS. 8-10 illustrate fusing apparatus 520 in more detail. Similar to fusing apparatus 420, fusing apparatus 520 comprises housing 524, fins 525, window 526, thermal reflector 530, heating device 532, airflow passage 534 and fan 540.

Housing 524 comprises an enclosure having an interior 541 containing reflectors 530 and heating device 532. In one implementation, the enclosure provided by housing 524 is substantially sealed (but for an inlet and outlet associated with an airflow passage as described below) to inhibit the entry of contaminants which might otherwise impair the performance of reflectors 530 or heating device 532. Although illustrated as elongated and rectangular, housing 524 may have a variety of sizes and shapes.

Fins 525 comprise thermally conductive structures formed from a metal, such as aluminum, and projecting inwardly from housing 524 within interior 541 between housing 524 and reflectors 530. Fins 525 conduct heat from the air within interior 41 to housing 524. As shown in FIG. 10, in the example illustrated, fins 525 are oriented so as to extend along axes parallel to the longitudinal axis of housing 24. As a result, fins 525 further guide and direct airflow along the longitudinal length of housing 524. In other implementations, fins 525 may be omitted.

Window 526 comprises an optical opening through which radiation from heating device 532 may pass, impinging the building material to heat and fuse the building material to which a coalescing agent has been applied. In one implementation, window 526 comprises a translucent or transparent panel that transmits the radiation from the interior 541 of housing 524 towards the building material. In such an implementation, window 526 further inhibit or impedes contaminants from entering enclosure 526 where they might otherwise become deposited upon reflectors 530 and/or heating device 532. In one implementation, window 526 comprises an optical filter, facilitating the transmission of selected wavelengths of radiation or light there through.

Thermal reflectors 530 comprise structures to reflect heat or radiation emitted by heating device 532 towards window 526. In one implementation, each of thermal reflectors 530 comprises a panel of a highly reflective material in the near, mid and far infrared region of the electromagnetic spectrum. In the example illustrated, thermal reflector 530 partially wraps about heating device 532 to further direct reflected heat downward through window 526. In the example illustrated, thermal reflectors 530 comprise a first reflector reflecting radiation from a warming unit of heating device 532 and a second reflector reflecting radiation from fusing units of heating device 532.

Thermal reflectors 530 are supported within the interior 541 of housing 524 and partition the interior 541 into back interior 542 and front interior 546. Back interior 542 extends behind reflectors 530 between reflectors 530 and housing 524. Front interior 546 extends in front of reflectors 530 between reflectors 530 and window 526.

Heating device 532 comprises a device to heat and fuse the building material of the additive manufacturing system in which fusing apparatus 520 is employed. Heating device 532 is supported by apparatus within front interior 546 opposite to window 526. Heating device 532 directs radiation through window 526 towards the building material. Radiation emitted by heating device 532 rearwardly is reflected by reflectors 530 back through window 526.

In the example illustrated, heating device 532 comprises a warming device 534 and fusing device 536. Warming device 534 comprises a lamp or multiple lamps that pre-warm the build material prior to fusing of the build material. Such warming units deliver energy to the build material so as to warm the build material to a temperature below its glass transition temperature. For example, in one implementation, such warming units may warm the building material to temperatures of between 145° C. and 175° C., and nominally between 155° C. and 165° C. In one implementation, the warming unit or units of warming device 534 may comprise a quartz infrared halogen lamp having a color temperature less than that of individual fusing units of fusing device 536. In one implementation, each warming unit may comprise such a lamp having a color temperature of 1800° Kelvin. In yet other implementations, heating device 532 comprise other types of warming units or may omit such warming units.

Fusing device 536 comprises at least one energy source to facilitate fusing or melting of the build material on which a coalescing agent from distributor 508 has been applied. In one implementation, the fusing unit(s) of heating device 32 comprises an infrared or near infrared light source. In one implementation, fusing device 536 comprises at least one energy source having a color temperature of 2750 degrees Kelvin. In one implementation, each of the fusing units of fusing device 538 comprises a quartz infrared halogen lamp to provide a uniform, high intensity irradiation to the powder of the build material. In one implementation, each of the lamps comprises a 1400 Watt lamp having a color temperature of 2750 K. In such an implementation, the lamps serving as the fusing units of fusing device 536 are operable to heat the building material (with any coalescing agents) to a temperature of at least 210° C., a temperature which is above the glass transition temperature of the building material to melt and fuse the building material to which a fusing control agent has been applied.

In other implementations, heating device 532 may comprise other sources for delivering sufficient amounts of energy to the build material so as to fuse the build material. For example, one implementation, heating device 532 may comprise multiple fusing units arranged end-to-end within housing 524. In another implementation, heating device 532 may comprise multiple fusing units arranged end-to-end in rows that are parallel. In still other implementations, heating device 532 may comprise a single elongated fusing unit.

In other implementations, the fusing units of heating device 532 may comprise other energy sources or other light sources. For example, in other implementations, other types of energy may be applied by heating device 532 such as microwave energy, halogen light, ultraviolet light and ultrasonic energy or the like. The type of energy as well as the duration of application of energy may vary depending upon factors such as the characteristics of heating device 532, the characteristics of the build material and the characteristics of any coalescence or fusing agents applied to the build material during the additive manufacturing process.

Airflow passage 534 is similar to airflow passage 34 described above. Airflow passage 534 comprises an air conduit extending through housing 524 through which air flows to cool interior components of fusing apparatus 520. Airflow passage 534 comprises inlet 550, outlet 552 and connector passage 554. Inlet 550 comprises an opening through which air, at a temperature of between 20° C. and 30° C., is supplied to back interior 542. As shown by FIG. 7, inlet 550 is connected to a conduit 545 by which air exterior to the additive manufacturing system may be drawn into interior 542.

Outlet 552 comprises an opening connected to front interior 546 through which air, which is absorb heat from reflectors 530 and from heating device 532, may be discharged from housing 526. Connector passage 554 comprises a conduit connecting back interior 542 to front interior 546. In one implementation, connector passage 554 has a cross-sectional area sufficient to allow air flow at a rate of at least 50 cubic feet per minute (CFM) and nominally at least 100 CFM from back interior 542 to front interior 546.

In the example illustrated, inlet 550 and outlet 552 are on the same end of housing 524. Airflow passage 534 is U-shaped such that air moves across an entire length of housing 526 and reflector 530, from inlet 550 to connector passage 554, before turning around and connector passage 554 and flowing across the entire length of housing 524 and heating device 532, prior to exiting through outlet 552. As a result, heat is absorbed by the air flowing behind reflector 530 along an entire length prior to entering interior 546. The air entering interior 546 flows across and cools substantially the entire length of heating device 532 prior to being discharged.

Fan 540 comprises a blower or other device to move air through airflow passage 534. In one implementation, fan moves air through airflow passage 534 at a rate of at least 50 CFM and nominally at least 100 CFM, in the example illustrated, fan 540 blows ambient air through inlet 550. In one implementation, fan 540 is connected to and supported by housing 524. In another implementation, fan 540 is supported by a housing of the overall additive manufacturing system, wherein a conduit extending from fan 540 is connected to inlet 550. As illustrated by broken lines, in other implementations, apparatus 520 may additionally or alternatively include a fan 558 which draws air from interior 541 through outlet 552.

In operation, build material distributor 504 forms a layer of build material on support 510. The agent distributor 506 selectively applies fusing control agents, such as a coalescing agent and, in some implementations, a detailing agent to the layer of build material pursuant to data regarding the three-dimensional object to be created. Thereafter, fusing apparatus 520 applies heat to the build material and applied agents to fuse those portions of the build material to which the coalescing agent has been applied. In one implementation, distributor 506 as well as fusing apparatus 520 are moved over and across support 510 of build area 502 by a carriage or other mechanism. Once such solidification occurs, the process is repeated to form the next slice or layer of the three-dimensional article or object being created. During use of fusing apparatus 520, controller 374 directs fan 40 (and/or 58) to direct air through interior 542 and through interior 546 to cool fusing apparatus 520 and maintain heating device 532 within an appropriate temperature range.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An additive manufacturing build material fusing apparatus comprising:
a housing;
a window;
a thermal reflector between the housing and the window;
a first interior behind the reflector between the housing and the reflector;
a second interior in front of the reflector between the reflector and the window;
a heating device in the second interior, the heating device comprising at least one heating unit;
an airflow passage having an inlet connected to the first interior, a connector passage connecting the first interior to the second interior and an outlet connected to the second interior; and
a fan to move air along the airflow passage.

2. The build material fusing apparatus of claim 1, wherein the heating device longitudinally extends within the housing from a first end to a second end, wherein the inlet and the outlet are on the first end and wherein the connector passage is on the second end.

3. The build material fusing apparatus of claim 1, wherein the reflector is thermally conductive so as to preheat air in the first interior prior to the air flowing into and cooling the heating lamp in the second interior

4. The build material fusing apparatus of claim 1 further comprising thermally conductive fins extending from the housing within the first interior.

5. The build material fusing apparatus of claim 1 further comprising a fan to direct air through the airflow passage.

6. The build material fusing apparatus of claim 5 further comprising:
a temperature sensor to sense a temperature of one of the first interior and the second interior; and
a controller to adjust a parameter of the fan based on the sensed temperature.

7. The build material fusing apparatus of claim 5 further comprising:
a first temperature sensor to sense a temperature of the first interior;
a second temperature sensor to sense a temperature of the second interior; and
Sa controller to adjust a parameter the fan based on the sensed temperature.

8. The build material fusing apparatus of claim 1 further comprising a second lamp within the second interior, wherein the lamp comprises a fusing lamp to heat build material to a first temperature and wherein the second lamp comprises a warming lamp to heat build material up to a maximum second temperature less than the first temperature.

9. The build material fusing apparatus of claim 1, wherein the build material fusing apparatus comprises a module releasably mountable to an additive manufacturing unit.

10. The build material fusing apparatus of claim 1, wherein the windows comprise light filters.

11. A method comprising:
activating a heating device within a first interior bounded by a reflector and a window;
directing air through a second interior bounded by a housing and the reflector to preheat the air; and
directing the preheated air from the second interior through the first interior to cool the heating device.

12. The method of claim 11 wherein the heating device longitudinally extends from a first end to a second end of the housing, wherein directing the air through the first interior comprises longitudinally directing the air from the first end through the first interior to the second end and wherein directing the air through the second interior comprises longitudinally directing the air from the second end to the first end.

13. The method of claim 11 further comprising activating the heating device to fuse build material within a build bed.

14. The method of claim 13 further comprising activating a second heating device to pre-warm warm build material prior to fusing of the build a material by the heating device.

15. An additive manufacturing system comprising:
a build area;
a build material distributor,
a coalescing agent distributor; and
a fusing apparatus, the fusing apparatus comprising:
a housing;
a window;
a thermal reflector between the housing and the window;
a first interior behind the reflector between the housing and the reflector;
a second interior in front of the reflector between the reflector and the window;
a heating device in the second interior, the heating device comprising at least one heating unit;
an airflow passage having an inlet connected to the first interior, a connector passage connecting the first interior to the second interior and an outlet connected to the second interior; and
a fan to move air along the airflow passage.
